(19) United States
(12) Patent Application Publication
(10) Pub. No.: US 2012/0024790 A1
(43) Pub. Date: Feb. 2, 2012

(54) SEPARATION COLUMN WITH GERMANIA-BASED SOL-GEL STATIONARY PHASE

(75) Inventors: Abdul Malik, Tampa, FL (US); Chengliang Jiang, Shanghai (CN); Li Fang, (US)

(73) Assignee: University of South Florida, Tampa, FL (US)

(21) Appl. No.: 13/150,935

(22) Filed: Jun. 1, 2011

Related U.S. Application Data
(63) Continuation-in-part of application No. 12/272,362, filed on Nov. 17, 2008.
(60) Provisional application No. 61/350,302, filed on Jun. 1, 2010.
(60) Provisional application No. 60/988,597, filed on Nov. 16, 2007.

(51) Int. Cl. B01D 15/08; B01D 53/04; B05D 7/22; B01D 15/22

(52) U.S. Cl. 210/656; 210/198.2; 96/101; 95/88; 427/235

(57) ABSTRACT

The present invention provides sol-gel germania-coated chromatography separation columns with improved stability under extreme pHs and high temperatures. Also provided are methods of preparation and uses of the sol-gel germania-coated separation columns of the present invention.

### CROSS REFERENCE TO RELATED APPLICATIONS

The present application claims the priority benefit of U.S. Application Ser. No. 61/350,302, filed Jun. 1, 2010, and is a continuation-in-part of U.S. Application Ser. No. 12/272,362, filed Nov. 17, 2008, which claims the priority benefit of U.S. Application Ser. No. 60/988,597, filed Nov. 16, 2007, which are herein incorporated by reference in their entirety.

### FIELD OF INVENTION

This invention relates to chromatographic separation columns.

### BACKGROUND

In recent years, sol-gel technology has attracted considerable interest among analytical chemists. Sol-gel chemistry provides an effective pathway for the synthesis of advanced organic-inorganic hybrid materials (Wang, D.; et al. Anal. Chem. 1997, 69, 4566-4576) in a wide variety of forms, including powders (Papacidero. A. T.; et al.; Colloids Surf A 2006, 275, 27-35), thin films (Muromachi, T.; et al. J. Sol-Gel Sci. Technol. 2006, 40, 267-272), ceramic fibers (Taylor, M. D.; Bhattacharya, A. K. J. Mater. Sci. 1999, 34, 1277-1279), and microporous inorganic membranes (Lin, Y. S.; et al. Sep. Purif. Methods 2002. 31, 229-379). The mild thermal conditions typical of sol-gel reactions not only allow chemical incorporation of a wide range of chemical species in the created material systems, but also ease the requirements for laboratory operation and safety. Sol-gel technology allows the use of a wide range of chemicals (both organic and inorganic) to integrate desirable properties in a single material system (Alhooshani, K.; et al. J. Chromatogr. A 2005, 1062, 1-14).

Silica-based stationary phases and sorbents are predominantly used in modern separation and sample preparation techniques. Silica surface chemistry and surface modification processes are well understood. However, the limitations of siliceous materials are also well-known. The pH stability problem is a major drawback of silica-based stationary phases and extraction media. The siloxane bond (Si—O—Si) on the silica surface hydrolyzes at pH>8 (Wehrli, A.; et al. J. Chromatogr. 1978, 149, 199-210), and the hydrolysis happens rapidly under elevated temperatures (Nawrocki, J.; et al. J. Chromatogr. 2004, 1028, 1-30). Under acidic conditions, the siloxane bond is also unstable (Glajch, J. L.; et al. J. Chromatogr. 1987, 384, 81-90), and stability worsens with elevated temperatures (McCalley, D. V. J. Chromatogr., A 2000, 902, 311-321; Synder, L. R.; et al. J. Practical HPLC Method Development; Wiley-Interscience: New York, 1996).

A number of methods such as multiple covalent bonds (Neus, U. D. Encyclopedia of Analytical Chemistry; Wlley: New York. 2001), multidentate synthetic approach (Kirkland, J. J.; et al. Anal Chem. 1989, 61, 2-11), and end capping (Sander, L. C.; et al. Crit Rev. Anal. Chem. 1987, 18, 299-415) have been used to improve the pH stability of silica-based stationary phases and sorbents. None of them, however, offers any effective solution. Therefore, developing sorbents with a wide range of pH stability is a fundamentally important area of research in chromatographic separation and sample preparation technology.

In 2007, the present inventors introduced the first open tubular column with germania-based sol-gel stationary phase for use in gas chromatography (GC) (L. Fang, S. Kulkarni, K. Alhooshani, A. Malik, Anal. Chem. 2007, 79 (24), 9441-9451). Exceptional pH and solvent stability of sol-gel germania-based materials (S. S. Segro, J. P. Triplett, A. Malik, Anal. Chem. 2010, 82, 4107-4113) can offer significant advantages to separation columns with sol-gel germania-based stationary phases over columns with traditional silica-based stationary phases. Accordingly, improved germania-based sol-gel stationary phase is needed.

### BRIEF SUMMARY

The present invention provides sol-gel germania-coated chromatography separation columns with improved performance. Advantageously, the sol-gel germania-coated separation columns can separate a variety of samples containing analytes from a diverse range of chemical classes. In one embodiment, the sol-gel germania-coated columns are gas chromatography columns.

One aspect of the invention provides a chromatography separation column, wherein a surface of the inner walls of the column comprises deactivated, sol-gel germania coating formed from a germanium alkoxide and/or hydrolyzed germanium alkoxide, a sol-gel active polymer, and a deactivating agent.

Another aspect of the invention provides methods of preparing sol-gel germania-coated gas chromatography separation columns. In one embodiment, the method comprises:

preparing a sol solution comprising a germanium alkoxide and/or hydrolyzed germanium alkoxide, a sol-gel active polymer, and a deactivating agent;

filling a column with the sol solution, and incubating the sol solution with inner walls of the column so that the sol-gel germania-polymer chemically binds to the inner walls of the column;

purging the column of unbound sol solution; and

thermally conditioning the sol-gel germania coating.

In one embodiment, the sol-gel germania-coated gas chromatography separation column is prepared using the preparation method of the present invention.

### BRIEF DESCRIPTION OF THE DRAWINGS

FIG. 1 is a GC analysis graph showing gas chromatography separation of alkanes on a sol-gel germania polydimethyldiphenylsiloxane (PDMDPS) column. Column conditions: 10-m×250 μm-i.d. fused silica capillary column; stationary phase, GeO₂-PDMDPS; carrier gas, helium; injection, split (100:1, 250° C.); detector, FID, 300° C.; temperature, from 80° C., at 10° C. min⁻¹. Detected peaks are as follows (1) C11, (2) C12, (3) C13, (4) C14, (5) C15, (6) C17, (7) C18, (8) C19, (9) C20, (10) C22, (11) C24.

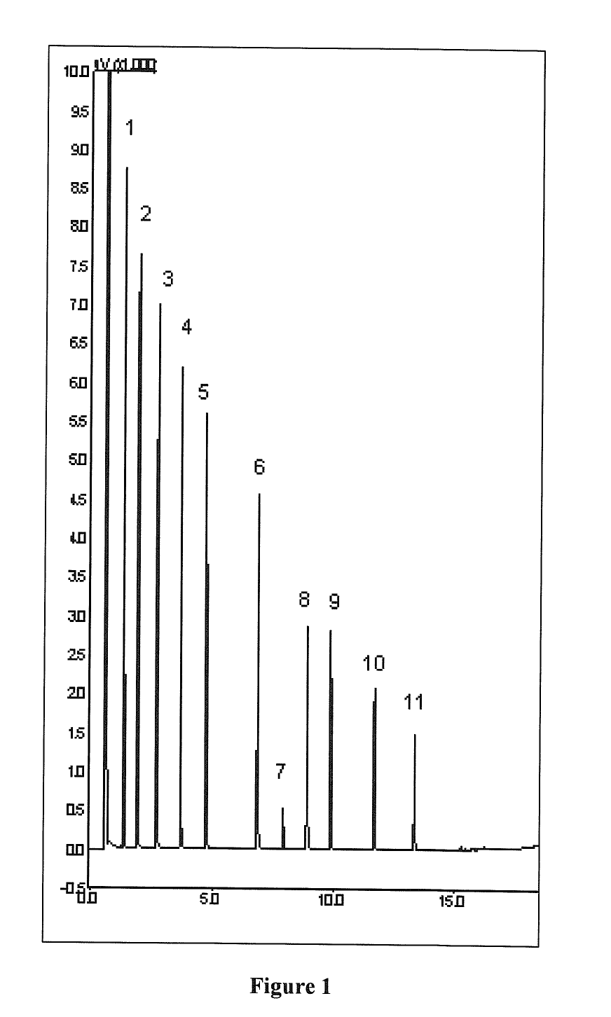

FIG. 2 is a GC analysis graph showing gas chromatography separation of PAHs on a sol-gel germania-PDMDPS column. Column conditions: 10-m×250-μm-i.d. fused silica capillary column; stationary phase, Ge-PDMDPS; carrier gas, helium; injection, split (150:1, 250° C.); FID 300° C.; temperature: from 80° C. at 6° C. min⁻¹. From 200, at 40 degree min-1 to 300 degree, remain 5 min. Detected peaks are as follows (1) Naphthalene, (2) Acenaphthene, (3) Fluorene (4) Phenanthene, (5) Fluroanthene, (6) Pyrene.

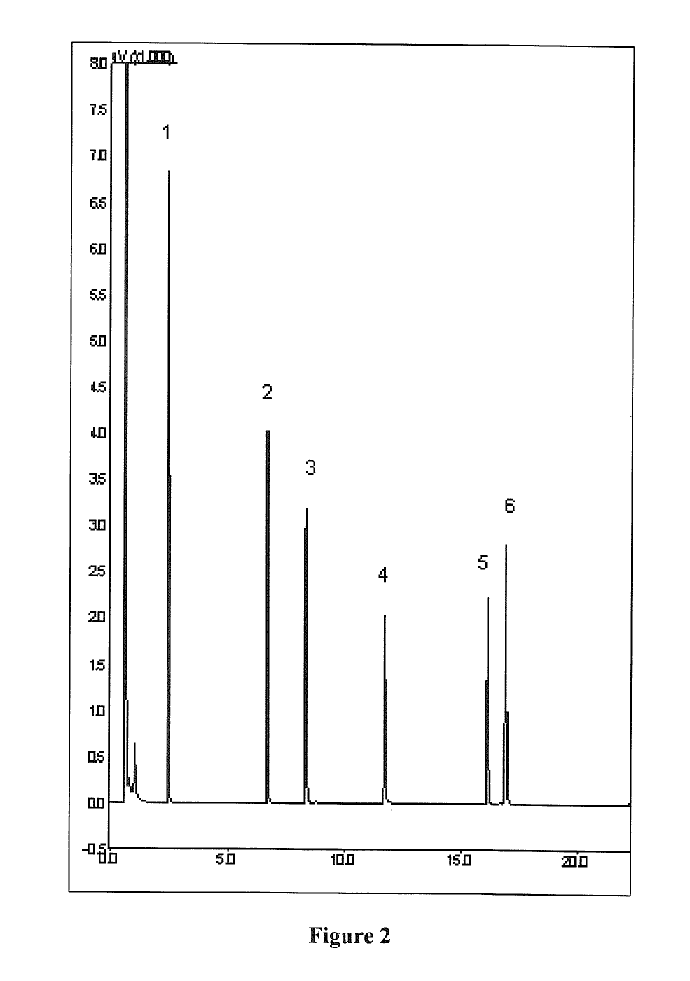

FIG. 3 is a GC analysis graph showing gas chromatography separation of PAH isomers on a sol-gel germania-PDMDPS column. Detected peaks are as follows: (1) Naphthalene, (2) Acenaphthene, (3) Fluorene, (4) Phenanthrene, (5) Anthracene, (6) Pyrene.

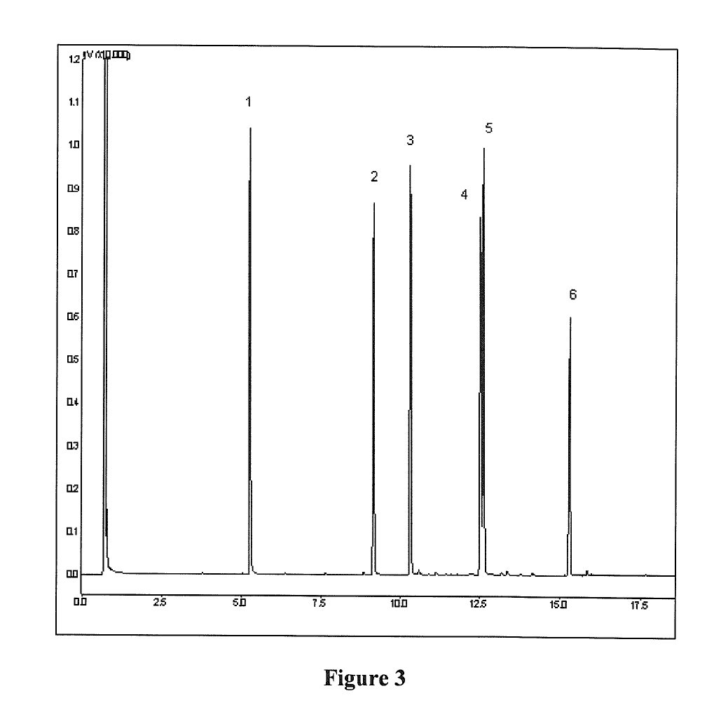

FIG. 4 is a GC analysis graph showing gas chromatography separation of ketones on a sol-gel germania-PDMDPS column. Column conditions: 10-m×250-μm-i.d. fused silica capillary column; stationary phase, sol-gel germania PDMDPS; carrier gas, helium; injection, split (100:1, 250° C.); detector, FID 300° C. Temperature programming: from 40° C. at 6° C. min⁻¹. From 200° C., at 40° C. min⁻¹ to 300° C., remain 5 min. Detected peaks are as follows: (1) Butyrophenone, (2) Valerophenone, (3) Hexanophenone, (4) Heptanophenone, (5) Benzenephone, (6) Decanophone.

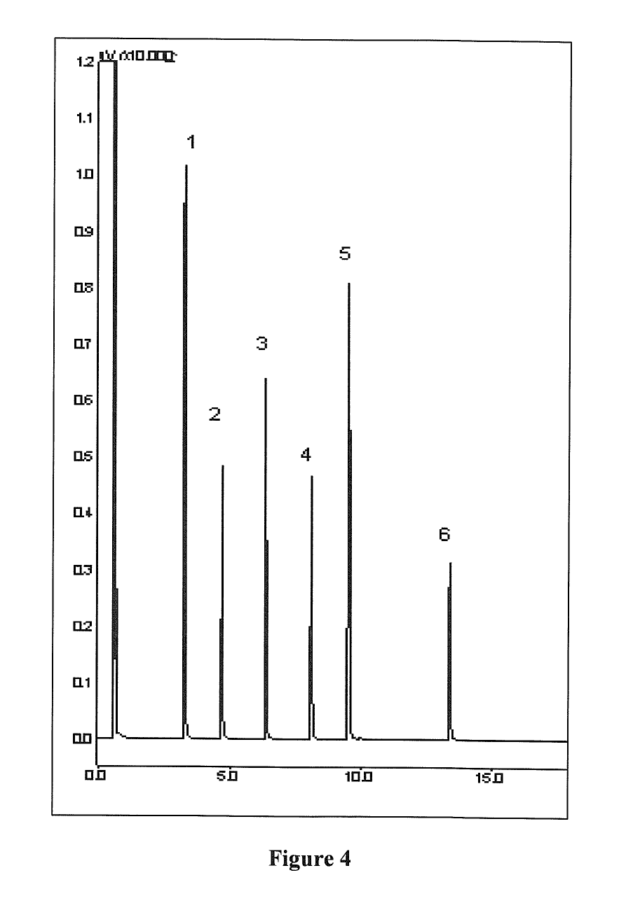

FIG. 5 is a GC analysis graph showing gas chromatography separation of Grob test mixture on a sol-gel Germania-PDMDPS column. Column conditions: 10-m×250-μm-i.d. Open tubular, sol-gel Germania-PDMDPS st. phase; carrier gas, helium; injection, split (100:1, 250° C.); detector, FID, 300° C.; temperature programming, 40° C. at 6° C. min⁻¹.

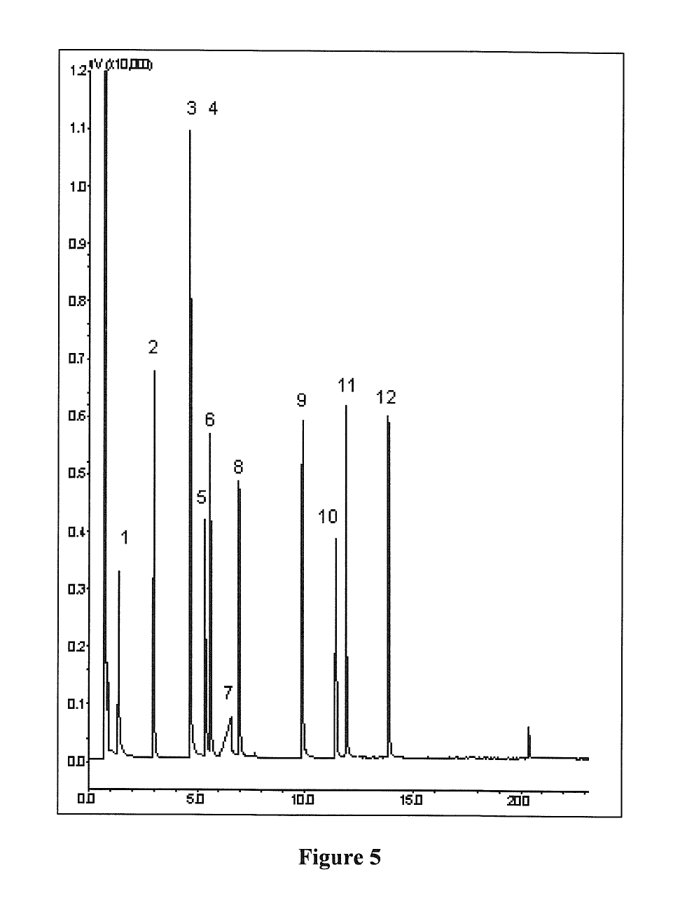

FIG. 6 is a GC analysis graph showing gas chromatography separation of pyridine at 50° C. on a Sol-Gel Germania-PDMDPS column. Column conditions: 10-m×250-μm-i.d. fused silica capillary column; stationary phase, sol-gel GeO₂-PDMDPS; carrier gas, helium; injection, split (100:1, 250° C.); detector, FID, 300° C.; temperature 50° C. (isothermal). Detected peaks are as follows: (1) Pyridine (9.4 ng).

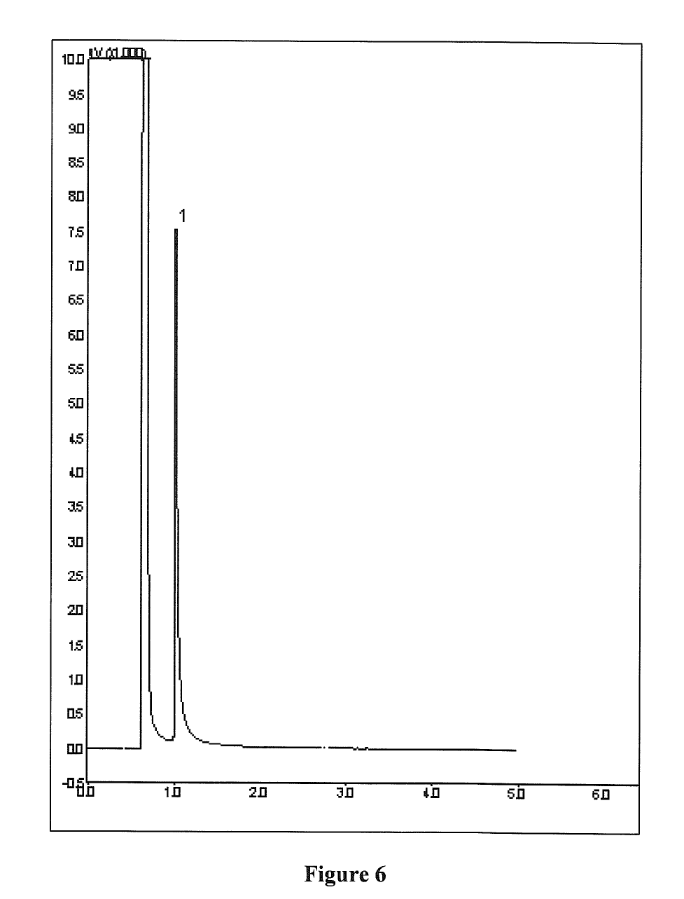

FIG. 7 is a GC analysis graph showing gas chromatography separation of phenols on a Sol-Gel germania-PDMDPS column. Column conditions: 10 m×0.25 mm i.d. fused silica column; stationary phase, sol-gel GeO₂-PDMDPS; injection, split (100:1, 250° C.); detector, FID, 300° C. Temperature programming: from 40° C. at 6° C. min⁻¹. Detected peaks are as follows: (1) 2,6-Dimethylphenol, (2) 2,5-Dimethylphenol, (3) 3,5-Dimethylphenol, (4) 2,3 Dimethylphenol, (5) 3,4-Dimethylphenol

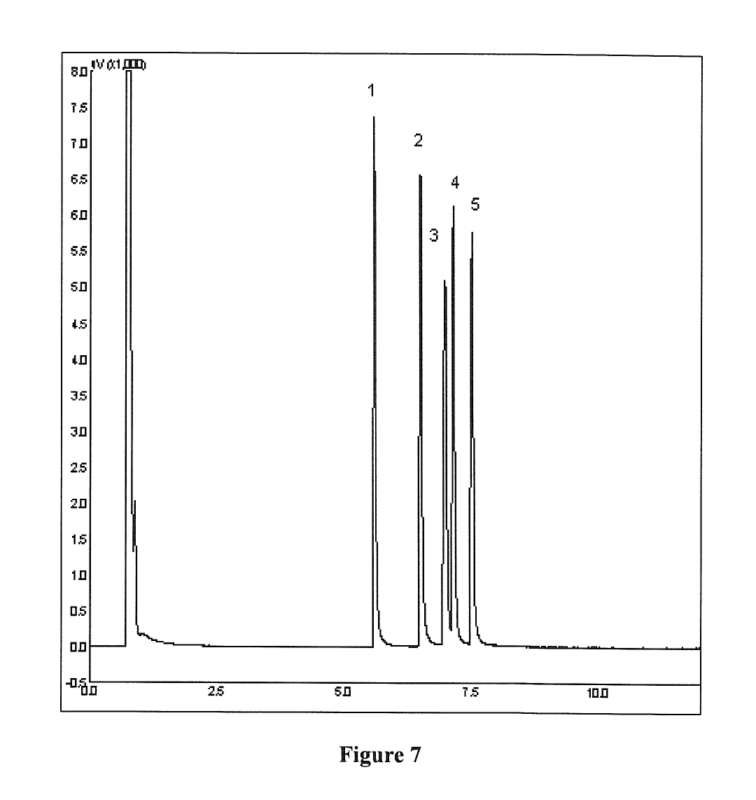

FIG. 8 is a GC analysis graph showing gas chromatography separation of test mixture consisting of analytes from different chemical classes. Column conditions: 10-m×250-μm-i.d. fused silica capillary column; stationary phase, sol-gel GeO₂-PDMDPS; carrier gas, helium; injection, split (100:1, 250° C.); detector, FID, 300° C. Temperature programming: from 40° C. at 6° C. Detected peaks are as follows: (1) Hexanoic acid, (2) 2,6-dimethylphenol, (3) 3,5-dimethylaniline, (4) 1-decanol, (5) Dicyclohexylamine, (6) methyl-n-undecanoate, (7) n-hexadecane, (8) n-octadecane, (9) Eicosane.

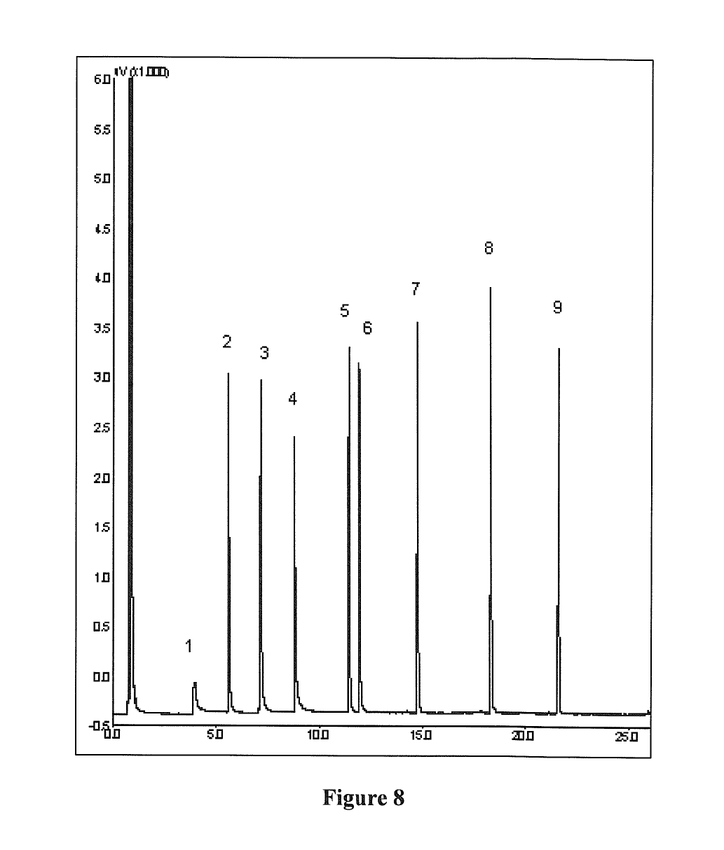

### DETAILED DESCRIPTION

In one embodiment, the present invention provides sol-gel germania-based gas chromatography (GC) separation columns with improved performance. Advantageously, the sol-gel germania-coated separation columns can separate a variety of samples containing analytes from a diverse range of chemical classes. In one embodiment, the sol-gel germania-coated columns are gas chromatography columns.

Germania-based stationary-phases have been added to separation columns using sol-gel technologies. The invention enhances stability of the GC separation column at extreme pHs and high temperatures, and, thus, overcomes the limitations in traditional silica-based stationary-phase separation columns. The outstanding stability under extreme pH conditions of the germania-based stationary-phases is surprising as germanium is below silicon on the periodic table and one would be expect that, just like silica, germanium would be characterized by the same trend of poor stability under extreme pH conditions. The germania-based stationary-phases can efficiently adsorb polar and non-polar analytes.

One aspect of the invention provides a chromatography separation column, wherein a surface of the inner walls of the column comprises deactivated, sol-gel germania coating formed from a germanium alkoxide and/or hydrolyzed germanium alkoxide, a sol-gel active polymer, and a deactivating agent.

Another aspect of the invention provides methods of preparing sol-gel germania-coated chromatography separation columns. In one embodiment, the method comprises:

preparing a sol solution comprising a germanium alkoxide and/or hydrolyzed germanium alkoxide, a sol-gel active polymer, and a deactivating agent;

filling a column with the sol solution, and incubating the sol solution with inner walls of the column so that the sol-gel germania-polymer chemically binds to the inner walls of the column;

purging the column of unbound sol solution; and

thermally conditioning the sol-gel germania-coated column.

In one embodiment, the present invention provides sol-gel germania-coated columns for use in gas chromatography (GC) and/or high-performance liquid chromatography (HPLC).

Advantageously, the sol-gel germania-coated chromatography column of the present invention has excellent pH stability across the ranges of about 0 or about 14, or at any pH in between 0 and 14.

The sol solution can be prepared from a suitable germanium alkoxide precursor. Germanium alkoxides useful according to the present invention include, but are not limited to, mon-, di-, tri-, and tetraalkoxy germanane, such as, tetraethoxygermane, tetramethoxygermane, tetrapropoxygermane, and tetrabutoxygermane. The germania-based sol-gel precursor can also be hydrolyzed germanium alkoxide monomers, dimers and/or trimers.

The sol-gel active polymers useful according to the present invention are known in the art, such as described in U.S. Pat. Nos. 6,759,126 B1 and 6,783,680 B2 and U.S. Patent Application Publication Nos. US 2002/0150923 A1, US 2003/0213732 A1, US 2004/0129141 A1 and US 2005/0106068 A1, the contents of which are incorporated herein by reference to the extent they are not inconsistent with the explicit teachings herein.

In one embodiment, the sol-gel active polymer is hydroxyl-terminated. In one embodiment, the sol-gel active polymers include, but are not limited to, poly(dimethylsiloxane), 3-amino-propyltrimethoxysilane, 3-cyanopropyltriethoxysilane, poly(dimethyldiphenylsiloxane), and polyethylene glycol.

In one embodiment, the sol-gel active polymer is a polyglycol. Polyglycols useful according to the present invention include, but are not limited to, polyethylene glycol, methoxypolyethylene glycol, polypropylene glycol, and polybutylene glycol. In a preferred embodiment, the sol-gel active polymer is polypropylene glycol. In certain embodiments, the sol-gel active polymer is selected from poly(dimethylsiloxane), 3-amino-propyltrimethoxysilane, 3-cyanopropyltriethoxysilane, poly(dimethyldiphenylsiloxane), or a combination thereof.

The deactivating agents useful according to the present invention include, but are not limited to, hexamethyldisilazane (HMDS) and polymethylhydrosiloxane (PMHS). In one embodiment, the deactivation agent is added to the sol solution. In one embodiment, the deactivation occurs during the thermal conditioning step.

In one embodiment, the chelating agent is selected from the group consisting of acetic acid, trifluoroacetic acid and metal beta-diketonates. In a preferred embodiment, the chelating agent is trifluoroacetic acid.

In one embodiment, the sol-gel germania-based polymer coating is chemically bonded to a surface of the inner walls of the capillary column. In one embodiment, the sol-gel germania-based polymer coating is covalently bonded to a surface of the inner walls of the capillary column.

In one embodiment, the thermal conditioning of the coated substrate is performed using temperature-programmed heating, wherein the heat increments upward from about 40° C. to about 320° C., or at any temperature therebetween, at an increment of about 1° C./minute to 5° C./minute, or at any increment therebetween, followed by a holding at about 250° C. to about 320° C., or at any temperature therebetween. The thermal conditioning of the coated column can be performed more than once.

In one embodiment, the inner walls of the capillary column are incubated with the sol solution for about 10, 15, 20, 25, 30, 35, 40, 45, 50, 55, or 60 minutes. In one embodiment, the sol solution chemically binds to the inner walls of the capillary column to form sol-gl germania-coated capillary column.

In one embodiment, the germania-based gas chromatography separation column is prepared using the preparation method of the present invention.

Another aspect of the invention provides a method for separating analytes from a sample using chromatography, comprising:

contacting a sample containing one or more analytes with the sol-gel germania-coated column of the invention; and

desorbing the analytes from the sol-gel germania coating.

In one embodiment, the method is performed using gas chromatography (GC) and/or high-performance liquid chromatography (HPLC).

In one embodiment, the germania-based gas chromatography separation column can effective separate a wide range of chemical analytes including, for example, polycyclic aromatic hydrocarbon (PAH), ketone, alcohol, phenol, amine, or a combination thereof. In one specific embodiment, the germania-based gas chromatography separation column can effective separate one or more analaytes from a sample, wherein the analytes are selected from the naphthalene, acenaphthene, fluorine, phenanthene, fluroanthene, pyrene, butyrophenone, valerophenone, hexanophenone, heptanophenone, benzenephone, decanophone, 2,6-dimethylphenol, 2,5-dimethylphenol, 3,5-dimethylphenol, 2,3-dmethylphenol, 3,4-dimethylphenol, hexanoic acid, 3,5-dimethylaniline, 1-decanol, dicyclohexylamine, methyl-n-undecanoate, n-hexadecane, n-octadecane, eicosane, or a combination thereof.

### EXAMPLES

Following are examples that illustrate procedures for practicing the invention. These examples should not be construed as limiting. All percentages are by weight and all solvent mixture proportions are by volume unless otherwise noted.

### Example 1

### Preparation of Germania-Based Gas Chromatography Separation Column

This Example illustrates one embodiment of preparing open tubular gas chromatography separation columns with sol-gel germania-based, organic-inorganic hybrid stationary phases. Specifically, the coating sol solution was prepared in a clean polypropylene centrifuge tube using tetraethoxygermane (TEOG) or other germanium alkoxide (sol-gel precursor), a sol-gel active polymer polydimethyldiphenylsiloxane (PDMDPS), a chelating agent trifluoroacetic acid (TFA), a deactivating agent (e.g., hexamethyldisilazane (HMDS), polymethylhydrosiloxane (PMHS)), water, in an appropriate solvent system (e.g., methanol, methylene chloride, tetrahydrofuran, acetonitrile, or a combination thereof). The amount of each mixture may vary based on the specific components used and amount of time desired for sol-gel formation.

For example, 15 μL of TEOG or other germanium alkoxide (sol-gel precursor), 5 mg of sol-gel active polymer (PDMDPS), 65 μL of chelating agent (TFA), a deactivating agent (e.g., HMDS, PMHS, etc), water, and 50 μL of an appropriate solvent system (e.g., methanol, methylene chloride, tetrahydrofuran, acetonitrile, or a combination thereof) may be added together. The mixture was then vortexed for 5 min followed by centrifugation for 4 min to remove possible precipitates. The clean supernatant was transferred to another clean vial, discarding the precipitate. A hydrothermally pretreated (Hayes, J.; Malik, A. Anal. Chem. 2001, 73, 987-996.) fused-silica capillary (1 m) was filled with the clear sol solution using pressurized helium (40 psi) in a filling/purging device. The sol solution was allowed to stay inside the capillary for 30 min to facilitate the formation of a sol-gel coating. During this residence period, a sol-gel network structure was developed inside the capillary in the form of individual patches. Some of these patches developing in the vicinity of the capillary inner walls have the opportunity to chemically anchor to the capillary surface through condensation reaction with the silanol groups on the capillary surface. This yielded a surface-bonded sol-gel germania-PDMDPS stationary phase coating.

Following this, the capillary was purged with helium (50 psi) for an hour to expel the unbonded portion of the sol solution leaving behind a dry surface-bonded sol-gel coating on the capillary inner walls. The capillary was further thermally conditioned under helium purge by programming the temperature from 40° C. to 250° C. at 1° C./min and held at the final temperature for 4 hours. The sol-gel coated capillary was then rinsed with a 1:1 (v/v) mixture of methylene chloride and methanol (2 mL), and then the capillary was conditioned again from 40° C.-250° C. at 5° C./min, from 250° C. to 300° C. at 1° C./min and held at final temperature for 1 hour. The conditioned capillary was then cut into 10-cm long pieces that were ready for use. For comparison purpose, a germania-CN capillary was prepared following the same above procedure, except that there is no hydroxy-terminated PDMS added in its sol solution. Sol-gel germania-PDMDPS and sol-gel germanian-APTMS coated capillaries were prepared in an analogous way by replacing hydroxyl-terminated PDMS in the sol solution either with hydroxylterminated PDMDPS or with hydroxylterminated APTMS.

Column deactivation was an important process responsible for this improved performance of the separation column. Contrary to the preparation of extraction columns for which deactivation is not of much importance, in the case of GC separation, column deactivation is the key to improved performance. The deactivating reagent(s) resulted in column deactivation during the thermal conditioning step. The exceptional pH- and solvent stability of sol-gel germania-based stationary phase can be expected to give significant advantages to columns with such stationary phases over columns with traditional silica-based stationary phases in terms of stability in performance and useful column lifetime.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A chromatography separation column, wherein a surface of the inner walls of the column comprises deactivated, sol-gel germania coating formed from a germanium alkoxide and/or hydrolyzed germanium alkoxide, a sol-gel active polymer, and a deactivating agent.

2. The chromatography separation column of claim 1, wherein the deactivating agent is selected from hexamethyldisilazane (HMDS) or polymethylhydrosiloxane (PMHS).

3. The chromatography separation column of claim 1, wherein the germanium alkoxide is selected from tetramethoxygermane, tetraethoxygermane, tetrabutoxygermane, or a combination thereof.

4. The chromatography separation column of claim 1, wherein the sol-gel active polymer is selected from poly(dimethylsiloxane), 3-amino-propyltrimethoxysilane, 3-cyanopropyltriethoxysilane, poly(dimethyldiphenylsiloxane), polyethylene glycol, or a combination thereof.

5. The chromatography separation column of claim 1, wherein the surface of the inner walls of the capillary column comprises fused silica.

6. The chromatography separation column of claim 1, wherein the column is a gas chromatography column.

7. A method of preparing a sol-gel germania-coated chromatography separation column, comprising:
preparing a sol solution comprising a germanium alkoxide and/or hydrolyzed germanium alkoxide, a sol-gel active polymer, and a deactivating agent;
filling a column with the sol solution, and incubating the sol solution with inner walls of the column so that the sol-gel germania-polymer chemically binds to the inner walls of the column;
purging the column of unbound sol solution; and
thermally conditioning the sol-gel germania-coated column.

8. The method, according to claim 7, wherein the deactivating agent is selected from hexamethyldisilazane (HMDS) or polymethylhydrosiloxane (PMHS).

9. The method, according to claim 7, wherein the germanium alkoxide is selected from tetramethoxygermane, tetraethoxygermane, tetrabutoxygermane, or a combination thereof.

10. The method, according to claim 7, wherein the sol-gel active polymer is selected from poly(dimethylsiloxane), 3-amino-propyltrimethoxysilane, 3-cyanopropyltriethoxysilane, poly(dimethyldiphenylsiloxane), polyethylene glycol, or a combination thereof.

11. The method, according to claim 7, wherein the surface of the inner walls of the capillary column comprises fused silica.

12. The method, according to claim 7, wherein the sol solution further comprises a chelating agent.

13. The method, according to claim 12, wherein the chelating agent is trifluoroacetic acid (TFA).

14. The method, according to claim 7, wherein the sol solution further comprises a solvent selected from methanol, methylene chloride, tetrahydrofuran, acetonitrile, or a combination thereof.

15. The method, according to claim 7, wherein the column is a gas chromatography column.

16. A chromatography separation column prepared using the method of claim 7.

17. A method for separating analytes from a sample using chromatography, comprising:
contacting a sample comprising one or more analytes with the sol-gel germania-coated column of claim 1; and
desorbing the analytes from the sol-gel germania coating.

18. The method of 17, wherein the method is performed using gas chromatography (GC) and/or high-performance liquid chromatography (HPLC).

19. The method of 17, performed at a pH of about 0 or about 14, or at any pH in between 0 and 14.

20. The method of claim 19, wherein the sample comprises one or more analytes selected from polycyclic aromatic hydrocarbon, ketone, alcohol, phenol, amine, or a combination thereof.
